(19) United States
(12) Patent Application Publication
(10) Pub. No.: US 2025/0308004 A1
(43) Pub. Date: Oct. 2, 2025

(54) DOCUMENT BOUNDARY DETECTION USING THE CURVATURE OF TEXT LINES

(71) Applicant: Adobe Inc., San Jose, CA (US)

(72) Inventors: Prasenjit MONDAL, Panchgechia (IN); Sachin SONI, New Delhi (IN)

(73) Assignee: Adobe Inc., San Jose, CA (US)

(21) Appl. No.: 18/617,279

(22) Filed: Mar. 26, 2024

(51) Int. Cl. G06T 5/80; G06T 7/13

(52) U.S. Cl. CPC G06T 5/80; G06T 7/13; G06T 2200/24; G06T 2207/20021; G06T 2207/30176

(57) ABSTRACT

Embodiments are disclosed for using the curvature of text lines to detect a document boundary. The method may include receiving a warped image depicting a page of a document having an incomplete document boundary, the page including a plurality of text lines. A complete document boundary may be identified based on the incomplete document boundary and the plurality of text lines. A dewarped image corresponding to the warped image may be determined using the complete document boundary. The dewarped image may then be provided for display on a client device.

### BACKGROUND

The accessibility of cameras allows users to effortlessly capture pages of a document. However, the presence of physical deformations like folds or curves can warp the appearance of the captured content. Warped content makes processing the document, such as automatically extracting information contained in the document, less accurate. Dewarping is the process of automatically straightening the appearance of content included in the document to improve the appearance of the captured image and/or increase the accuracy of downstream processes like automatic information extraction.

### SUMMARY

Introduced here are techniques/technologies that determine a document boundary using the content of the document. The dewarping system described herein leverages the content of the document to calculate a document boundary. The content of the document is used by the dewarping system to determine a representative point in a probable document boundary region. A set of representative points are used to calculate a complete document boundary. The complete document boundary is a smooth curve that indicates the boundary of the document and contains all of the content of the document.

More specifically, in one or more embodiments, the dewarping system described herein determines text curves using text content and subsequently determines parallel curves using each of the determined text curves. The set of parallel curves is used to create a probable document boundary region. A grid is generated by partitioning the document into equidistant vertical and horizontal lines. The intersection of the grid and the set of parallel curves is used to obtain a representative point that is contained within the probable document boundary region. The dewarping system iterates the methods and processes described herein for each parallel curve and each vertical or horizontal line of the grid to obtain a set of representative points. Subsequently, a parametric curve is fit to the set of representative points to determine a complete document boundary.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of dewarping an image of a document, in accordance with one or more embodiment;

FIG. 2 illustrates examples of different images of captured documents, in accordance with one or more embodiments;

FIG. 3 illustrates an example of the boundary detector, in accordance with one or more embodiments;

FIG. 4 illustrates text curves of an input document, in accordance with one or more embodiments;

FIG. 5 illustrates an example of a set of parallel curves based on text curves of an upper half of a document, in accordance with one or more embodiments;

FIG. 6 illustrates n vertical equidistant lines applied to a document, in accordance with one or more embodiments;

FIG. 6A illustrates an example probable document boundary region, in accordance with one or more embodiments;

FIG. 7 illustrates an example of determining a representative point in the probable document boundary region, in accordance with one or more embodiments;

FIG. 8 illustrates an example of the dewarping module, in accordance with one or more embodiments;

FIG. 9 illustrates an example of deploying the dewarping system, in accordance with one or more embodiments;

FIG. 10 illustrates a schematic diagram of a dewarping system, in accordance with one or more embodiments;

FIG. 11 illustrates a flowchart of a series of acts in a method of determining a document boundary to dewarp an image, in accordance with one or more embodiments; and

FIG. 12 illustrates a block diagram of an exemplary computing device in accordance with one or more embodiments.

### DETAILED DESCRIPTION

One or more embodiments of the present disclosure include a dewarping system that generates a complete document boundary using the content of the document. One conventional approach dewarps a document by assuming the completed document boundary is present and/or visible in an image of the document. For example, some conventional approaches guide the user in real time to capture a complete document boundary and subsequently dewarp or otherwise process the captured image using the complete document boundary. One conventional approach dewarps an image by guiding the user to capture a dewarped image. For example, prompts are displayed to the user, allowing the user to align the content of the document with the prompts. Additionally or alternatively, the user receives instructions such as “move camera left” or “move camera up.”

These approaches assume a complete document boundary can be captured to process or otherwise dewarp the image and/or dewarp the image in real time by providing feedback to the user. Accordingly, these approaches do not perform well to process or otherwise dewarp cropped images, where a cropped image is an image that does not include the complete document boundary. For example, a stored image may be content-focused. A content-focused image is an image in which the majority of the image of the document is the content of the document. Therefore, in a content-focused image, the document boundary is not included in the image (e.g., the document boundary is cropped out of the image). Many scanning applications or image-capture applications encourage the user to capture such content-focused images that do not include a complete document boundary.

To address these and other deficiencies in conventional systems, the dewarping system of the present disclosure uses the content of a document captured in an image to determine a complete document boundary. The dewarping system described herein can advantageously dewarp any image, including stored images that are cropped. The ability to determine the document boundary improves the capability of one or more downstream processes dewarping the image of the document. For example, curved text captured in an image of a document can be more accurately flattened when the dewarping processes are provided a document boundary of the image of the document. As a result of improved dewarping processes, fewer dewarping attempts are needed to accurately dewarp the image. For instance, multiple dewarping attempts are not needed to dewarp the image because the dewarping system of the present disclosure can accurately dewarp the image in a single pass. Accordingly, computing resources such as power, bandwidth and/or memory are conserved because dewarping is performed less frequently as a result of the higher accuracy dewarping by the dewarping system of the present disclosure. While dewarping is described, it should be appreciated that other downstream processes can also be improved using the determined document boundary.

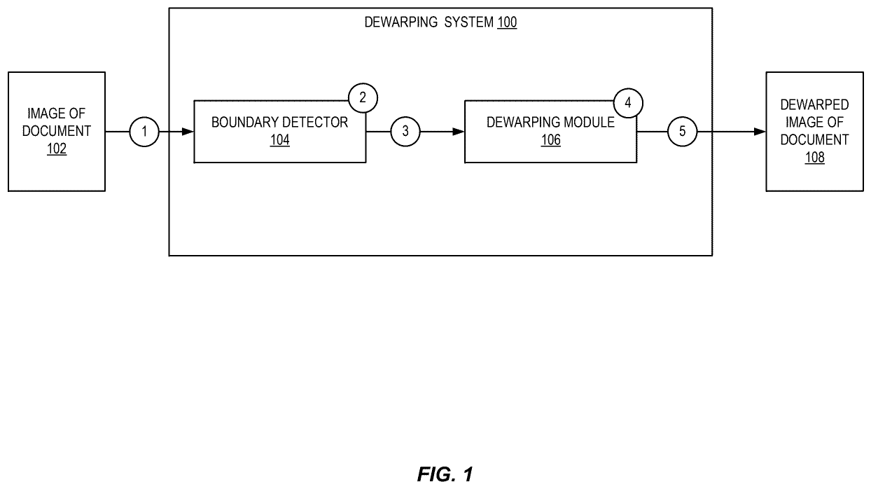

FIG. 1 illustrates a diagram of a process of dewarping an image of a document, in accordance with one or more embodiments. In some embodiments, the dewarping system 100 may be implemented as part of an image processing suite of software. In some embodiments, a user may access the image processing suite of software via a client application executing on their computing device (e.g., a desktop, laptop, mobile device, etc.). In some embodiments, the client application (or “app”) may be an application provided by the image processing suite of software or other entity. Additionally, or alternatively, the user may access the image processing suite of software via a browser-based application executing in a web browser installed on the user's computing device. Additionally, or alternatively, the image processing suite of software may be implemented entirely or in part on the user's computing device. In some embodiments, the dewarping system of the image processing suite of software is automatically executed responsive to receiving an image (such as an image of a document 102).

In some embodiments, the dewarping system 100 of the image processing suite of software is only executed responsive to determining that the received image includes a threshold amount of warping. For example, a component of the dewarping system 100 (not shown) can generate a reference line across the image of the document 102 and compare the reference line to a set of points. In some implementations, the set of points includes one or more points of the complete boundary determined by the boundary detector 104. Responsive to determining that the difference between one or more points of the reference line and the one or more points of the set of points satisfies a threshold, the image of the document 102 is dewarped (e.g., passed to the dewarping module 106).

As shown at numeral 1, the input is an image of a document 102. A user can upload the image of the document 102 and/or the dewarping system 100 can receive the image from a database or other upstream process. In some embodiments, the input image is a frame of a video. For example, a user may video themselves flipping through pages of the book and a frame capturing a page of the book can be input as the image of the document 102. The image of the document 102 can include a single page of text and/or other content such as tables, figures, or other graphics. For ease of description, the input image of the document 102 is described herein as a cropped image of a document, even though the systems and processes described herein can be applied to an uncropped image of a document.

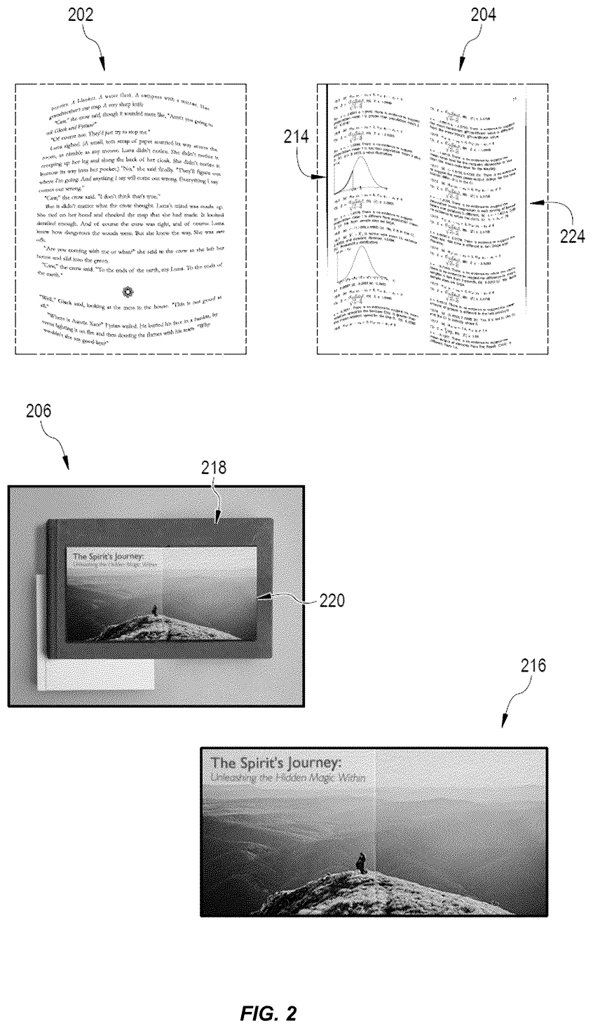

A cropped image of a document is an image of a document that is content-focused (e.g., the image maximizes the view of the content by removing non-content information such as the document boundary). For example, one or more upstream processes may extract or otherwise emphasize the content of the image. During such extraction, straight lines are used to discard portions of the image that are not content. Accordingly, the straight lines can crop the image such that the image is not a complete representation of the image of the document 102 (e.g., one or more portions of the image of the document 102 are removed such as the boundary of the document). Additionally or alternatively, the image of the document 102 can be captured with an incomplete document boundary. Accordingly, the cropped image of the document is a document with at least a portion of a distorted document boundary (e.g., an absent document boundary or a partial document boundary). Examples of cropped images are illustrated in FIG. 2 below.

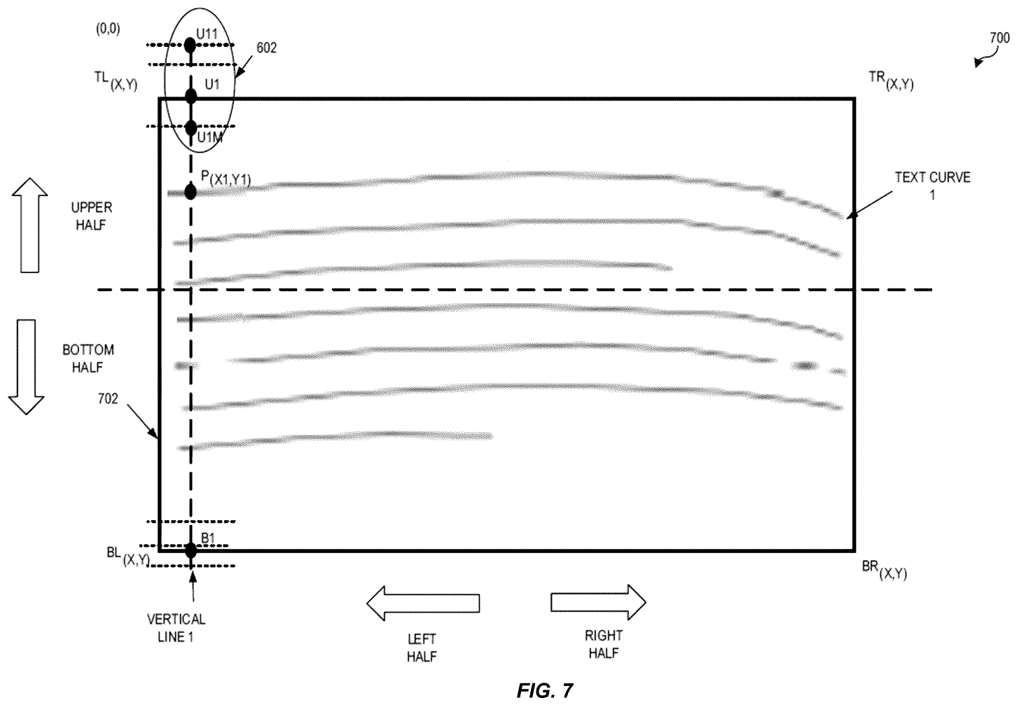

At numeral 2, a boundary detector 104 determines a complete document boundary based on the image of the document 102. The complete document boundary can be represented as a smooth curve (e.g., a non-discrete and continuous curve) that contains all of the content of the document captured in the image of the document 102. The boundary detector is described in more detail in FIG. 7 below.

The document boundary is passed to the dewarping module 106 at numeral 3. The dewarping module 106 also receives the image of the document 102. In some embodiments, the image of the document 102 and the document boundary are received by the dewarping module 106 separately. For example, the dewarping module 106 receives the image of the document 102 and the dewarping module 106 also receives the document boundary (e.g., coordinates of the document boundary, a mathematical expression of a curve that fits the document boundary, or some combination). In other embodiments, the image of the document 102 and the document boundary are received together. For example, the dewarping module 106 receives the document boundary overlaid on the document 102.

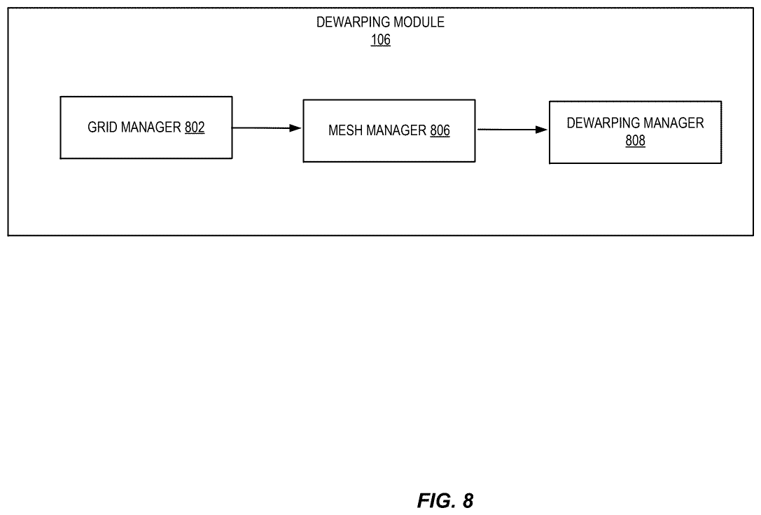

At numeral 4, the dewarping module 106 dewarps the image of the document 102 using the document boundary. The dewarping module 106 can perform any one or more dewarping processes to dewarp the image of the document 102 using the document boundary. An example dewarping module 106 is described in FIG. 8. While dewarping module 106 is shown, other downstream processes can receive the document boundary and/or the image of the document 102. For example, using the document boundary, one or more downstream processes can measure an amount of warp in the document (e.g., a quantity of warping).

At numeral 5, the dewarping system 100 outputs a dewarped image of the document 108. The dewarped image of the document 108 includes the same content as the image of the document 102 but is dewarped. For example, text that appears visually curved in the image of the document 102 (e.g., warped content) appears visually flat in the dewarped image of the document 108.

FIG. 2 illustrates examples of different images of captured documents, in accordance with one or more embodiments. Example 202 illustrates a cropped image. As shown, the document boundary of example 202 is not shown (e.g., the image content has been cropped). Example 202 illustrates a content-focused input image because the majority of the image is content. Example 204 illustrates a second example of a cropped image. Unlike example 202, in which no portions of the document boundary are included in the image of the document (e.g., the document boundary is absent from the image of the document), in example 204, portions of the document boundary 214 and 224 are present in the image of the document. Because only portions of the document boundary 214 and 224 are present in the image, the document boundary is partial or otherwise incomplete. Example 204 illustrates a second content-focused input image because the majority of the image is content.

Example 206 illustrates an uncropped image with a background. The dark portion around the document content indicates a background 218 captured with the document. The background contrasts with the image, resulting in a defined document boundary 220. The document boundary 220 is the line that distinguishes or otherwise segments the content of the document from the background 218. Example 216 illustrates a version of example 206 that includes the document boundary (e.g., the boundary bordering the content of the image). The background in example 206 is cropped from the image such that example 216 is a content-focused image. The content of the image in example 216 is the majority of the image. As described herein, in some embodiments, cropped images of documents are received as the input image of the document 102. Accordingly, examples 202 and 204, could be inputs to the boundary detector 104 of the dewarping system 100. In some embodiments, examples 206 and 216 could be inputs to the boundary detector 104 of the dewarping system 100.

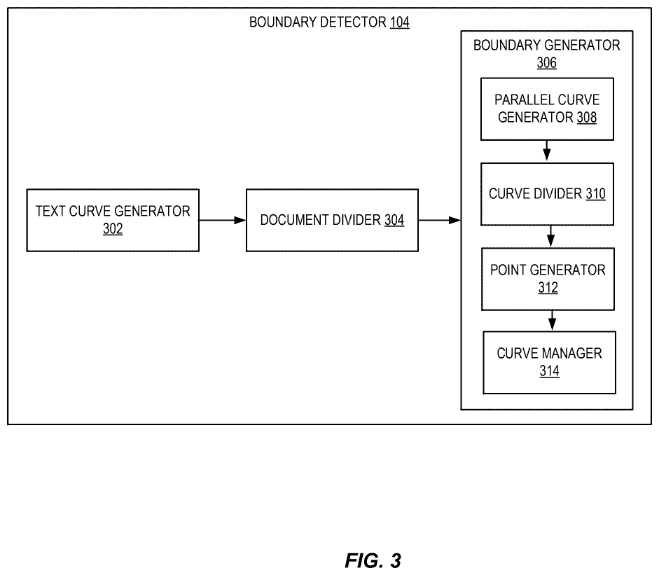

FIG. 3 illustrates an example of the boundary detector, in accordance with one or more embodiments. The boundary detector 104 is used to determine the document boundary based on the content of the image of the document.

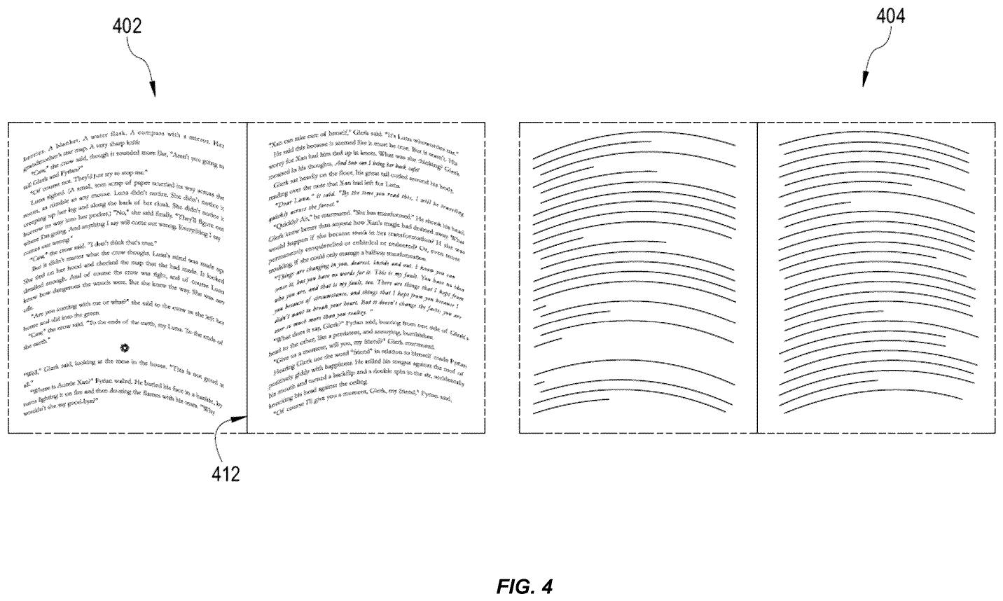

The text curve generator 302 receives the image of the document 102 and determines one or more curves corresponding to text content of the document (e.g., text lines included in the image of the document 102). In some embodiments, the text curve generator 302 executes one or more image processing algorithms to identify characters of text in the image of the document 102. For example, the text curve generator 302 can perform optical character recognition (OCR) to determine the bounding boxes around each character of text. Subsequently, the text curve generator 302 can determine the center of each bounding box. The text curve generator 302 determines curves corresponding to the text content by connecting the center of each bounding box associated with each character of text context using straight line segments. Accordingly, the text curve generator 302 determines text curves that correspond to each text line of the text content included in the image of the document 102. In some embodiments, in addition to determining bounding boxes, OCR can be used to obtain coordinates of each bounding box and an orientation of each character associated with each bounding box. In this manner, the text curve generator 302 determines text position information. FIG. 4 illustrates an input document 102 and text curves determined by the text curve generator 302 from the text content of the image of the document 102.

In some embodiments, the text curve generator 302 is a machine learning model configured to determine a curve corresponding to a text line of the image of the document 102. For example, instead of using OCR to identify text characters and obtain bounding boxes associated with each character, the text curve generator 302 can use one or more machine learning algorithms trained to predict a position of text content of the image of the document 102. For example, the machine learning algorithm can predict the probability of an image pixel belonging to a character of content (e.g., text content of the document) to predict the position of text content of the image of the document. Subsequently, the text curve generator 302 generates a text curve using the position of the text content by connecting the center of each character of text context using straight line segments.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

The document divider 304 divides the image of the document 102 into halves using text curves such that a first set of text curves is included in a first half of the document and a second set of text curves is included in a second half of the document. For example, the document divider 304 divides the image of the document 102 horizontally to generate an upper half of the document and a bottom half of the document. The two halves are passed to the boundary generator 306 such that the boundary generator 306 can determine a document boundary corresponding to the upper half of the document and a document boundary corresponding to the bottom half of the document. The document divider 304 also divides the image of the document 102 vertically to generate a left half of the document and a right half of the document. The two halves are passed to the boundary generator 306 such that the boundary generator 306 can determine a document boundary corresponding to the right half of the document and a document boundary corresponding to the left half of the document.

In some embodiments, the document divider 304 divides the image of the document 102 such that the number of text curves included in each half of the document is the same. For example, each half of a document can include eight text curves corresponding to eight lines of text if the document includes a total of 16 lines of text. If there are an odd number of text curves of the document, then one half of the document will include one more text curve than the other half of the document.

The boundary generator 306 generates boundary curve sides of a document. The operations of the boundary generator 306 are repeated for each side of the document. For example, given a page of a book (e.g., each page has four sides), the operations of the boundary generator 306 are repeated four times. For instance, the boundary generator 306 determines an upper document boundary during a first iteration, a bottom document boundary during a second iteration, a left document boundary during a third iteration, and a right document boundary during a fourth iteration. In other words, the document divider 304 passes a pair of halves (e.g., two sides) to the boundary generator 306 given a single document division performed by the document divider 304. Responsive to receiving an upper half of the document and a lower half of the document (caused by a first iteration of document division performed by the document divider 304), the boundary generator 306 determines an upper document boundary during a first iteration and the lower document boundary during a second iteration. Subsequently, responsive to receiving a right half of the document and a left half of the document (caused by a second iteration of document division performed by the document divider 304), the boundary generator 306 determines a right document boundary during a third iteration and a left document boundary during a fourth iteration.

Each side of a document boundary (e.g., represented by the upper document boundary, the bottom document boundary, the right document boundary, and the left document boundary) are connected such that the full document boundary smoothly connects each of the sides of the document boundary. For instance, a Bezier curve or other parametric representation smoothly connects the sides of the document boundary to obtain the full/complete document boundary.

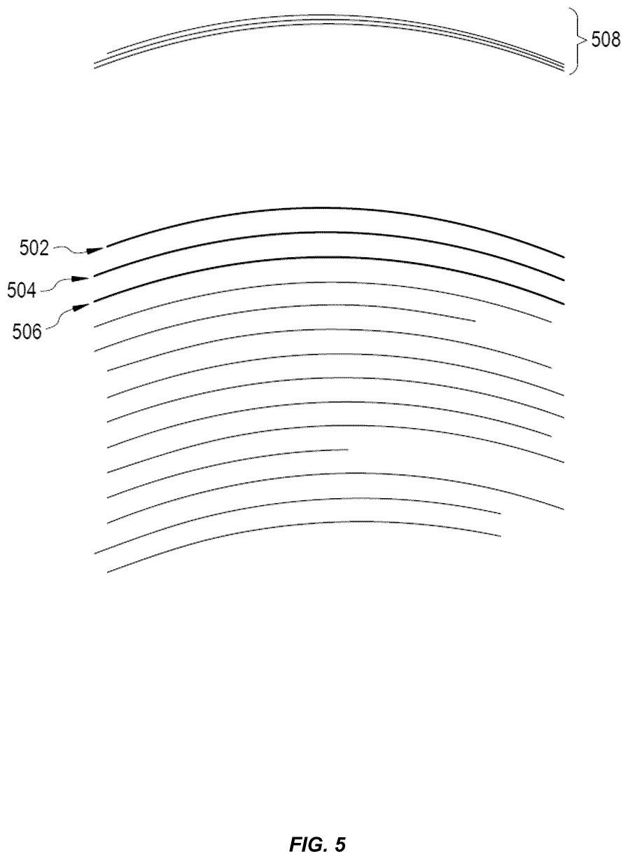

The parallel curve generator 308 applies an offset value d to each generated text curve to determine a parallel curve corresponding to lines of text in the document (e.g., the text content). For example, given a text curve that can be representing using a regular parametric representation (e.g., x=x(t)), the parallel curve generated by the parallel curve generator 308 can be represented as x_{d}=x(t)±dn(t), where n(t) is the unit normal and d is a positive value. Such parallel curves are horizontal parallel curves that can be used to determine the upper and bottom document boundaries, as described herein. In some embodiments, the parallel curve generated by the parallel curve generator 308 can be represented as x_{d}=x(t)⊥dn(t). Such parallel curves are vertical parallel curves that can be used to determine the left and right document boundaries. The parallel curve generator 308 applies the offset value d to each text curve in a half of the document to generate a set of parallel curves. In some embodiments, the value d used to offset the parallel curve from the text curve is predetermined. For example, d can be a margin size. The value of d is selected such that the parallel curves are located at a position in the document such that the text curves are contained within the bounds of the parallel curves. For example, the parallel curve generator 308 can determine the value of d for the upper half of the document based on the text curves included in the upper half of the document. The parallel curve generator 308 determines the value of d such that none of the text curves intersect with the parallel curves on the upper half of the document. Accordingly, the parallel curve generator 308 can determine d based on a pixel threshold above the coordinates of the topmost text curve included in the upper half of the document. FIG. 5 illustrates an example of a set of parallel curves based on text curves of an upper half of a document.

The curve divider 310 is used to generate a grid of the document. In operation, the curve divider 310 applies n equidistant lines to the document based on the width (or height) of the document. Each of the n equidistant lines intersect the set of parallel curves. For example, the equidistant lines intersect the first set of parallel curves associated with the top half of the document and the second set of parallel curves associated with the bottom half of the document. Accordingly, a first grid is generated for the top half of the document and a second grid is generated for the bottom half of the document. The intersection of the parallel curves (associated with text curves) and the n equidistant lines (based on the width or height of the document) generates the grid corresponding to the half of the document. Further, the intersection of each line and the set of parallel curves in a grid creates a probable document boundary region associated with the intersecting line (e.g., an equidistant line of the n equidistant lines).

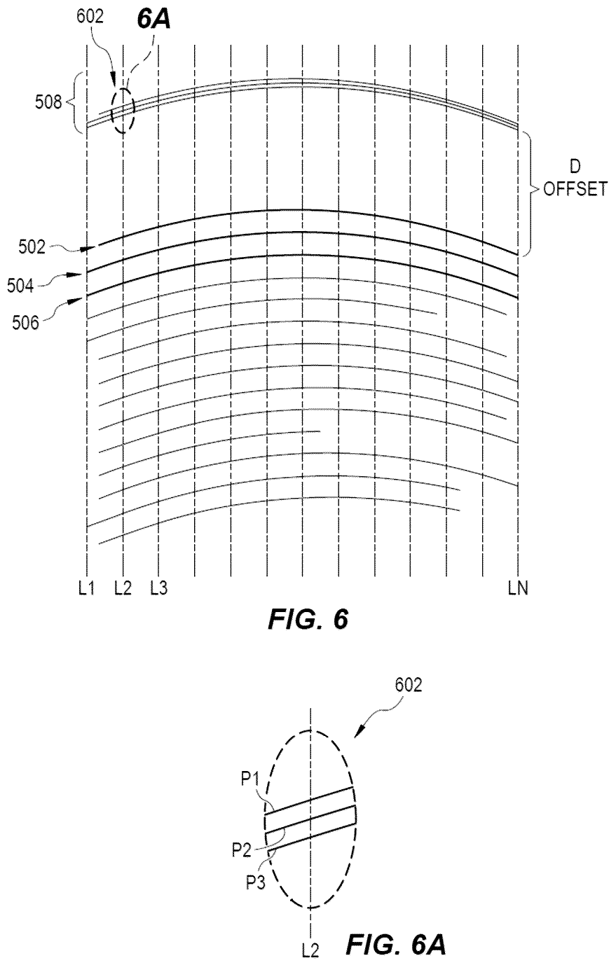

The document boundary for two sides of the document is determined using one set of equidistant lines. For example, curve divider 310 applies n equidistant vertical lines for use by the point generator 312 to determine both an upper side of the document boundary and a lower side of the document boundary. In some embodiments, the curve divider 310 applies m equidistant horizontal lines used by the point generator 312 to determine both the right side and the left side of the document boundary. In some embodiments, m and n are the same value and in other embodiments m and n are different values. Each vertical line is used to compute the upper boundary and the bottom boundary, and each horizontal line is used to compute a right boundary and a left boundary. FIG. 6 illustrates n vertical equidistant lines applied the document and intersecting a first set of parallel curves.

The point generator 312 determines a representative point in each probable document boundary region. The representative point is associated with a set of parallel curves intersecting each equidistant line. The document boundary for a side of the document is determined using representative points associated with each equidistant line across the width (or height) of the side of the document.

The curve manager 314 fits a curve to each of the representative points across the side of the document. For example, the curve manager 314 fits the set of representative points of the upper side of the document to generate an upper document boundary, the curve manager 314 fits the set of representative points of the bottom side of the document to generate a bottom document boundary, the curve manager 314 fits the set of representative points of the left side of the document to generate a left document boundary, and the curve manager 314 fits the set of representative points of the right side of the document to generate a right document boundary.

The curve manager 314 also fits each document boundary side together to generate the complete (or full) document boundary. The complete document boundary is a smooth continuous curve.

FIG. 4 illustrates text curves of an input document, in accordance with one or more embodiments. The input document 402 is a cropped document, as indicated by a portion of the document boundary 412. That is, the document boundary is distorted (e.g., partial or otherwise incomplete). The input document 402 is a content-focused document because the majority of the document includes content. Text curves in example 404 correspond to the text content of the input document 402. Text curves are determined by the text curve generator 302, described above.

FIG. 5 illustrates an example of a set of parallel curves based on text curves of an upper half of a document, in accordance with one or more embodiments. As described herein, each text curve 502-506 is offset by a distance d to obtain a set of parallel curves 508. In operation, the regular parametric representation (e.g., x=x(t)) of a text curve is offset by a distance d such that the parallel curve can be represented as x_{d}=x(t)+dn(t), where n(t) is the unit normal and d is a positive value. The parallel curve generator 308 generates the set of parallel curves, as described above.

FIG. 6 illustrates n vertical equidistant lines applied to a document, in accordance with one or more embodiments. As shown in FIG. 6, n equidistant lines L₁, L₂ . . . L_{N} intersect the set of parallel curves 508. FIG. 6A illustrates an example probable document boundary region, in accordance with one or more embodiments. In FIG. 6A, the probable document boundary region 602 is illustrated as the intersection of the set of parallel curves 508 at line L₂. A first parallel curve of the set of parallel curves intersects line L₂ at location P1, which is contained within the region 602; a second parallel curve of the set of parallel curves intersects line L₂ at location P2, which is contained within the region 602; and a third parallel curve of the set of parallel curves intersects line L₂ at location P3, which is contained within the region 602.

FIG. 7 illustrates an example of determining a representative point in the probable document boundary region, in accordance with one or more embodiments. For ease of illustration, other vertical lines of the set of n equidistant vertical lines are not illustrated in example 700. Additionally, only a portion of each parallel curve of the set of parallel curves is illustrated in the probable document boundary region (e.g., the dashed lines in the probable document boundary region 602).

As described herein, a set of representative points associated with each side of a document is used to determine a complete document boundary. In example 700, the complete document boundary is illustrated as 702, which includes an upper side U determined using the upper half, a bottom side B determined using the bottom half, a left side L determined using the left half and a right side R determined using the right half. The upper side is determined from the set of representative points determined using n vertical lines, U=U₁, U₂, . . . , Uₙ. Similarly, the bottom side is determined from the set of representative points determined using n vertical lines B=B₁, B₂, . . . , Bₙ. The point U₁ and B₁ are points on the same vertical line (illustrated as vertical line 1) and belong on different grid. For example, the point U₁ is associated with a grid of the upper side of the document and the point B₁ is associated with a grid of the bottom side of the document. The right side and left sides are similarly defined as R=R₁, R₂, . . . , Rₙ and L=L₁, L₂, . . . , Lₙ which includes the set of points corresponding to each line n. After the point generator 312 has determined a set of points of U, B, L or R the curve manager 314 computes a polynomial of degree n to represent the document boundary for the side corresponding to the completed set of points. An example polynomial is illustrated in Equation (1) below:

$$f ( x ) = {a}_{n} {x}^{n} + {a}_{n - 1} {x}^{n - 1} + {a}_{n - 2} {x}^{n - 2} + … + {a}_{2} {x}^{2} + {a}_{1} x + {a}_{0} \qquad ( 1 )$$

For example, given a set of points determined for the upper side U, the polynomial function is completed using the determined representative points U₁, U₂, . . . , Uₙ. The curve represented by the polynomial function computed using the representative points in the set of U is the upper side of the document boundary. The bottom side, right side, and left sides of the document boundary are computed similarly using the set of representative points of B, R, and L respectively.

A representative point is computed based on an intersection of a vertical line (e.g., one equidistant vertical line of the set of n equidistant vertical lines) and the set of parallel curves. In other words, text curves used to generate parallel curves are used to determine representative points. The probable document boundary region is visually represented as region 602 and includes the set of parallel curves that intersect vertical line 1. As shown, region 602 includes a set of points U₁₁ . . . U_{1M} where M represents the number of text lines contained in the upper half of the document. Each of points U₁₁ . . . U_{1M} represent the intersection of the parallel curve with a vertical line (e.g., vertical line 1). The representative point associated with vertical line 1 is labeled U₁ (e.g., an upper document boundary point). The representative point is based on a set of parallel curves intersecting each vertical line. Equation (2) below illustrates calculating the ith representative point set of the upper side document boundary point.

$${U}_{i} = \frac{{\sum }_{j = 1}^{M} {U}_{ij}}{M} \qquad ( 2 )$$

In Equation 2 above, the representative point (e.g., upper document boundary point Uᵢ) is calculated for the set of N vertical lines (e.g., i∈{1, . . . , N). M represents a number of parallel curves of the set of parallel curves. In other words, the representative point is the average of intermediate points Uᵢⱼ with respect to M parallel curves. Similar equations exist to calculate representative points of the bottom side document boundary (e.g., Bᵢ) using intermediate points Bᵢⱼ, representative points of the left side document boundary (e.g., Lᵢ) using intermediate points Lᵢⱼ, and representative points of the right side document boundary (e.g., Rᵢ) using intermediate points Rᵢⱼ.

Example 700 illustrates the set of intermediate points (e.g., U₁₁ . . . U_{1M}) for the upper document boundary point U₁. Accordingly, for each side, the point generator 312 generates M intermediate points and N representative points.

The location of each intermediate point is determined based on edges of the document and each text curve. The document boundary 702 has four edges, which are represented as T_{L}, T_{R}, B_{L}, B_{R} corresponding to the top left point on the upper boundary, the top right point on the upper boundary, the bottom left point on the bottom boundary, and bottom right point on the bottom boundary respectively. A coordinate system can be superimposed on the document. For example, the top right corner of the document (not shown) has a coordinate value of (0,0) for instance, and the bottom left corner of the document (not shown) has a coordinate value of (dimension of the document in pixels, dimension of the document in pixels). Each point T_{L}, T_{R}, B_{L}, B_{R} is represented using (x,y) coordinates such that the top left point T_{L} is represented by T_{L}=(T_{Lx}, T_{Ly}), the top right point T_{R} is represented by T_{R}=(T_{Rx}, T_{Ry}), the bottom left point B_{L} is represented by B_{L}=(B_{Lx}, B_{Ly}), and the bottom right point B_{R} is represented by B_{R}=(B_{Rx}, B_{Ry}).

The location of each intermediate point can be calculated with respect to the edges of the document according to Equation (3) below:

$${B}_{11} = {p}_{y 1} - ( β \times {Δ}_{B} ) + [ ( 1 - β ) \times {Δ}_{U} ] \qquad ( 3 )$$

$${U}_{11} = {p}_{x 1} - ( α \times {Δ}_{R} ) + [ ( 1 - α ) \times {Δ}_{L} ]$$

$${L}_{11} = {p}_{y 1} - ( β \times {Δ}_{L} ) + [ ( 1 - β ) \times {Δ}_{R} ]$$

$${R}_{11} = {p}_{x 1} - ( α \times {Δ}_{U} ) + [ ( 1 - α ) \times {Δ}_{B} ]$$

Equation (3) illustrates an example of the calculation of intermediate points B₁₁ and U₁₁. As shown in Equation (3) above, the calculation of the intermediate points includes coordinate information of the text curve p(x,y). For example, the intermediate point U₁₁, representing the intermediate point of the upper document boundary based on the first vertical line and the first parallel curve includes the coordinate pₓ₁, which represents the horizontal position (x) of the first text curve (e.g., the text curve used to generate the parallel curve). Equation (4) below illustrates an example of how to calculate the deviation for each intermediate point and the horizontal and vertical position parameters.

$${Δ}_{{U}_{i}} = {u}_{{x}_{i}} - {TL}_{x} \qquad ( 4 )$$

$${Δ}_{{B}_{i}} = {b}_{{x}_{i}} - {BL}_{x}$$

$${Δ}_{{L}_{i} = {l}_{{y}_{i}}} - {TL}_{y}$$

$${Δ}_{{R}_{i} = {r}_{{y}_{i}}} - {TR}_{y}$$

$$α = \frac{horizontal position of p ( x , y )}{number of vertical line} , where 0 \leq α \leq 1$$

$$β = \frac{vertical position of p ( x , y )}{number of vertical line} , where 0 \leq β \leq 1$$

In Equation (4) above, TLₓ and TL_{y} represent the coordinates of the top left edge of the document. The terms uₓ_{ᵢ}, bₓ_{ᵢ}, l_{y}_{ᵢ}, r_{y}_{ᵢ}, represent distances between a point p(x,y) and the upper document boundary, the bottom document boundary, the left document boundary, and the right document boundary respectively. The horizontal position of p(x,y) is the distance between the position p and the left document boundary and/or the right document boundary (e.g., the image horizontal boundary). The vertical position of p(x,y) is the distance between a position p and the top document boundary and/or the bottom document boundary (e.g., the image vertical boundary). As described above, other edges of the document have similar coordinates.

FIG. 8 illustrates an example of the dewarping module, in accordance with one or more embodiments. While the example dewarping module 106 uses a grid manager 802, a mesh manager 804, and a dewarping manager 806, one or more other dewarping algorithms or processes can be executed by the dewarping module 106. As described herein, the dewarping module is configured to receive the input document 102 and the document boundary determined by the boundary detector 104, and determine a dewarped image using the document boundary.

In some embodiments, the grid manager 802 generates a grid using the document boundary. For example, the grid manager 802 selects points of the document boundary and generates straight lines from each of the selected points. In some embodiments, points are selected along the document boundary at equidistant locations. The mesh manager 804 generates a mesh overlay for the document 102 based on the selected points of the document. For example, mesh polygons are generated using intermediate points of the document based on the selected points of the document. The dewarping manager 806 generates a dewarped document using the mesh overlay. For example, the mesh overlay computed using the intermediate points of the document is compared to a uniform polygon mesh. A difference between the uniform polygonal mesh and warped mesh overlay is computed to determine a shift applied by the dewarping manager 806 to the content of the document. Applying the shift to the content of the document dewarps the content of the image, causing the document to appear visually flat or dewarped.

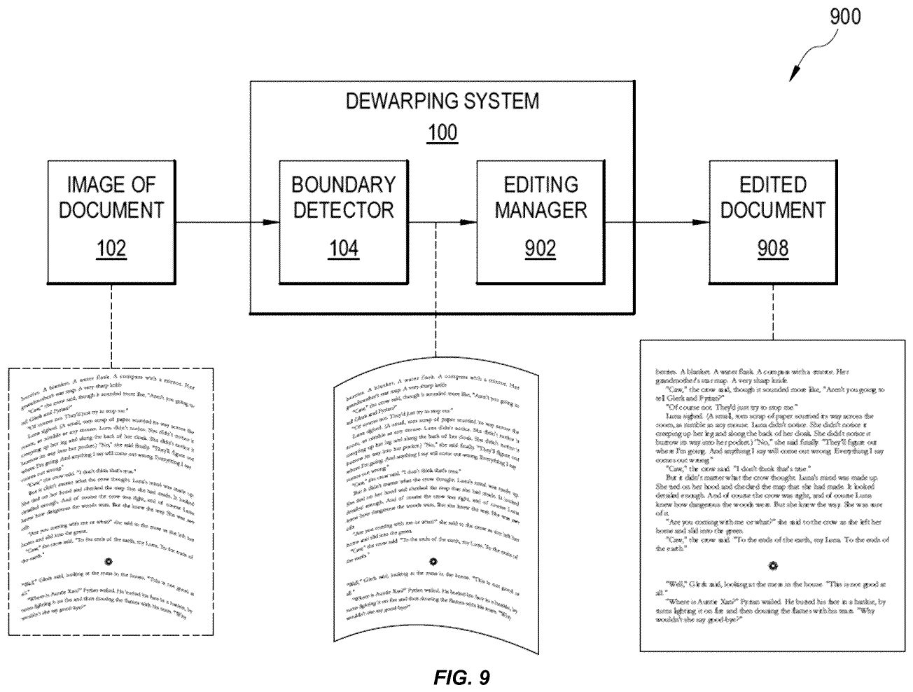

FIG. 9 illustrates an example of deploying the dewarping system, in accordance with one or more embodiments. An image of a document with a partial or removed document boundary (e.g., an absent document boundary) can reduce the accuracy of downstream processes performed by editing manager 902. Accordingly, the user may select, using a graphical user interface (GUI), an indication to dewarp the image of document 102 such that the editing manager 902 can accurately perform a downstream process (such as edit the image of the document 102). In some embodiments, the user may select, using the GUI, an indication to perform the downstream process (such as an editing process performed by the editing manager 902). Responsive to the indication to perform the editing process, the dewarping system 100 automatically dewarps the image using the boundary detector 104 before performing the editing process.

The image of the document 102 can be any image including a cropped image without a document boundary. In other words, a line (e.g., the document boundary) is not visible in the image of the document 102 to segment the content of the document with respect to a background.

The image of the document is passed to the boundary detector 104 such that the boundary detector can determine the document boundary using the content of the image of the document 102. As described herein, boundary curves are determined for each side of a document and subsequently connected to determine the complete document boundary. The complete document boundary is a collection of document boundaries associated with each side of the document. For example, the complete document boundary is a continuous representation of the left document boundary, the right document boundary, the upper document boundary, and the lower document boundary. Each document boundary is determined using a curve that fits a set of representative points, where each point of the set of representative points is determined using intermediate points included in a probable document boundary region. Each probable document boundary region is generated based on an intersection of an equidistant line of a set of equidistant lines and a set of parallel curves. The set of parallel curves are based on text curves corresponding to text content of the document, and the set of equidistant lines is part of a grid generated based on a width (or height) of a document and the text curves.

The editing manager 902 receives the image of the document 102 and the superimposed document boundary. In other embodiments, the editing manager 902 receives the image of the document 102 and the document boundary determined by the boundary detector 104 (e.g., coordinates of the document boundary, a mathematical expression of a curve that fits the complete document boundary, or some combination).

The editing manager 902 can perform any one or more downstream processes. In a non-limiting example, a user may seek to extract information from the image of the document using any one or more automatic information extraction processes performed by the editing manager 902. However, an image of a document with a partial or removed document boundary can cause the extraction of information from the document to be inaccurate or otherwise incomplete. Accordingly, the editing manager 902 extracts information from the document using the document boundary as a reference.

In another non-limiting example, a user may seek to edit content of the image of the document using any one or more editing processes performed by the editing manager 902. However, editing processes may be unable to identify the characters or content of the image of the document without using the document boundary to establish the bounds of the document. In other words, a user may not be able to accurately edit the document without the one or more downstream editing processes obtaining the document boundary. Accordingly, the editing manager 902 edits content of the document using the document boundary as a reference.

In yet another non-limiting example, a user may seek to dewarp content of the image of the document using any one or more dewarping processes performed by the editing manager 902. However, such dewarping processes may not be able to accurately flatten curved content of the warped image of the document without using the document boundary as a reference line, for instance. Accordingly, the editing manager 902 dewarps the document using the document boundary as a reference.

The output of the editing manager 902 is edited document 908. The edited document 908 can be a dewarped document with edited content and/or a dewarped document with original content (e.g., content included in the image of the document 102). For example, the content of the edited document 908 appears visually flat, making it easier for humans to read and understand and also easier for OCR or other downstream processes. In some embodiments, the edited document 908 is passed to subsequent downstream processes.

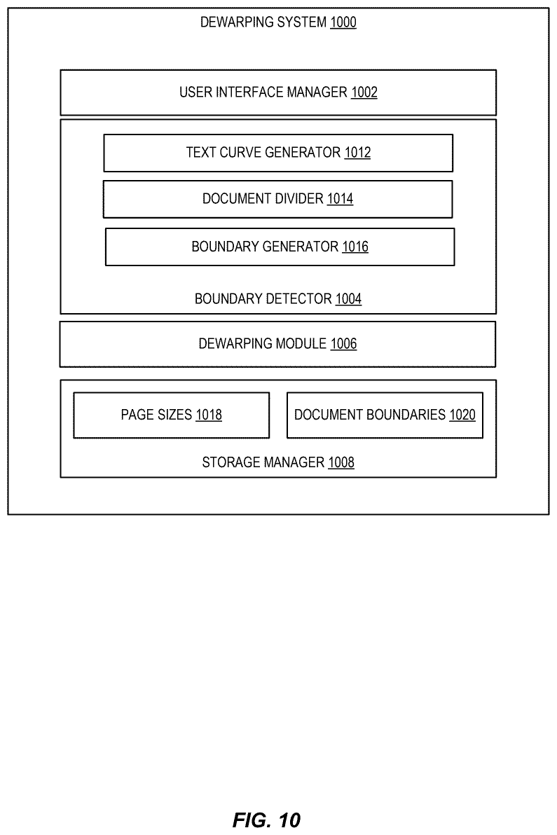

FIG. 10 illustrates a schematic diagram of dewarping system (e.g., “dewarping system” described above) in accordance with one or more embodiments. As shown, the dewarping system 1000 may include, but is not limited to, a user interface manager 1002, a boundary detector 1004, a dewarping module 1006 and a storage manager 1008. The boundary detector 1004 includes a text curve generator 1012, a document divider 1014, and a boundary generator 1016.

As illustrated in FIG. 10, the dewarping system 1000 includes a user interface manager 1002. For example, the user interface manager 1002 allows users to provide images of documents to the dewarping system 1000. In some embodiments, the user interface manager 1002 provides a user interface through which the user can upload or otherwise select images of a document to be dewarped or otherwise processed. For example, a user can select an image of a document to be processed such that one or more image processing algorithms perform optical character recognition (OCR) on the image of the document. In some embodiments, before the image of the document is processed, the dewarping system 1000 dewarps the image such that the downstream processes are performed with higher accuracy. Alternatively, or additionally, the user interface may enable the user to download the images of the document from a local or remote storage location (e.g., by providing an address (e.g., a URL or other endpoint) associated with the document storage). In some embodiments, the user interface can enable a user to link an image capture device, such as a camera or other hardware to capture image data and provide it to the dewarping system 1000. The user interface manager 1002 can also display dewarped images.

As illustrated in FIG. 10, the dewarping system 1000 includes a boundary detector 1004. The boundary detector 1004 determines a complete document boundary based on an input image of a document. The complete document boundary can be represented as a smooth curve (e.g., a non-discrete and continuous curve) that contains all of the content of the document.

The boundary detector 1004 includes a text curve generator 1012. The text curve generator 1012 determines one or more curves corresponding to the text content of the document. For example, text curves are associated with lines of text included in the document. In some embodiments, the text curve generator 1012 determines text position information associated with the text content of the document.

The boundary detector 1004 also includes a document divider 1014. The document divider 1014 divides a document into halves, where each half of the document is based on a number of text curves. For example, the document divider 1014 divides the document into a first half using a first set of text curves and a second half using a second set of text curves. The number of text curves in each half is equal (or off by one if a total number of text curves is odd). The document divider 1014 divides the document into two pairs of halves to determine the document boundary. For example, the document divider 1014 divides the image of the document horizontally to generate an upper half of the document and a lower half of the document. The document divider 1014 also divides the image of the document vertically to generate a left half of the document and a right half of the document. Each pair of halves (upper half/bottom half and right half/left half) is passed to the boundary generator 1016 to determine a side of the document boundary corresponding to the pair of halves. For example, the boundary generator 1016 determines an upper side and a bottom side for the upper half and bottom half pair, and the boundary generator 1016 determines a right side of the document boundary and a left side of the document boundary for the right half and left half pair.

The boundary detector 1004 also includes a boundary generator 1016. The boundary generator 1016 generates a boundary curve for each side of the document. As described herein, parallel curves are generated for each text curve in a half of a document to generate a set of parallel curves. A grid is generated based on a width/height of the document and the text curves. For example, n equidistant vertical lines are generated across the width of the document Additionally or alternatively, n equidistant horizontal lines are generated across the height of the document. Each of the lines intersect the set of parallel curves, which are based on the text curves (e.g., the content of the document). The intersection of the lines and the set of parallel curves creates a probable document boundary. Each probable document boundary region is used to obtain a representative point based on a set of intermediate points, and the set of representative points are fit to obtain a curve for a side of the document. Curves for each side of the document are fit to obtain the complete document boundary.

As illustrated in FIG. 10, the dewarping system 1000 includes a dewarping module 1006. The dewarping module 1006 dewarps the image of the document using the document boundary. The dewarping module 1006 can perform any one or more dewarping processes to dewarp the image of the document using the document boundary.

As illustrated in FIG. 10, the dewarping system 1000 also includes the storage manager 1008. The storage manager 1008 maintains data for the dewarping system 1000. The storage manager 1008 can maintain data of any type, size, or kind as necessary to perform the functions of the dewarping system 1000. The storage manager 1008, as shown in FIG. 10, includes page sizes 1018. Page sizes 1018 include common widths and/or heights of pages. In some embodiments, page sizes 1018 are stored for use by the curve divider (e.g., curve divider 310 described herein). For example, the curve divider applies n equidistant lines to the document based on a stored page size 1018 (e.g., width or height) associated with the document.

As further illustrated in FIG. 10, the storage manager 1008 also includes document boundaries 1020. In some embodiments, after the boundary detector 1004 determines a document boundary of a document captured in an image, the dewarping system 1000 stores the document boundary such that one or more downstream processes can use the document boundary associated with the document captured in the image. For instance, a document captured in an image is tagged with the document boundary determined by the boundary detector 1004. The document boundary and associated document captured in the image can be used by the dewarping module 1006 as described herein to dewarp the document captured in the image. Additionally or alternatively, other downstream processes use the document boundary and associated document captured in the image.

Each of the components 1002-1010 of the dewarping system 1000 and their corresponding elements (as shown in FIG. 10) may be in communication with one another using any suitable communication technologies. It will be recognized that although components 1002-1008 and their corresponding elements are shown to be separate in FIG. 10, any of components 1002-1008 and their corresponding elements may be combined into fewer components, such as into a single facility or module, divided into more components, or configured into different components as may serve a particular embodiment.

The components 1002-1008 and their corresponding elements can comprise software, hardware, or both. For example, the components 1002-1008 and their corresponding elements can comprise one or more instructions stored on a computer-readable storage medium and executable by processors of one or more computing devices. When executed by the one or more processors, the computer-executable instructions of the dewarping system 1000 can cause a client device and/or a server device to perform the methods described herein. Alternatively, the components 1002-1008 and their corresponding elements can comprise hardware, such as a special purpose processing device to perform a certain function or group of functions. Additionally, the components 1002-1008 and their corresponding elements can comprise a combination of computer-executable instructions and hardware.

Furthermore, the components 1002-1008 of the dewarping system 1000 may, for example, be implemented as one or more stand-alone applications, as one or more modules of an application, as one or more plug-ins, as one or more library functions or functions that may be called by other applications, and/or as a cloud-computing model. Thus, the components 1002-1008 of the dewarping system 1000 may be implemented as a stand-alone application, such as a desktop or mobile application. Furthermore, the components 1002-1008 of the dewarping system 1000 may be implemented as one or more web-based applications hosted on a remote server. Alternatively, or additionally, the components of the dewarping system 1000 may be implemented in a suite of mobile device applications or “apps.”

As shown, the dewarping system 1000 can be implemented as a single system. In other embodiments, the dewarping system 1000 can be implemented in whole, or in part, across multiple systems. For example, one or more functions of the dewarping system 1000 can be performed by one or more servers, and one or more functions of the dewarping system 1000 can be performed by one or more client devices. The one or more servers and/or one or more client devices may generate, store, receive, and transmit any type of data used by the dewarping system 1000, as described herein.

In one implementation, the one or more client devices can include or implement at least a portion of the dewarping system 1000. In other implementations, the one or more servers can include or implement at least a portion of the dewarping system 1000. For instance, the dewarping system 1000 can include an application running on the one or more servers or a portion of the dewarping system 1000 can be downloaded from the one or more servers. Additionally or alternatively, the dewarping system 1000 can include a web hosting application that allows the client device(s) to interact with content hosted at the one or more server(s).

For example, upon a client device accessing a webpage or other web application hosted at the one or more servers, in one or more embodiments, the one or more servers can provide access to one or more documents (e.g., images of documents captured using a scanning device or camera) stored at the one or more servers. Moreover, the client device can receive a request (i.e., via user input) to perform one or more downstream processes using the document and provide the request to the one or more servers. For example, a user can request to edit a selected document. Upon receiving the request, the one or more servers can automatically perform the methods and processes described above to determine a document boundary of the document such that the one or more downstream processes can be performed. For example, the one or more servers are used to determine a document boundary and subsequently use the document boundary to edit the document according to user inputs. The one or more servers can provide the edited document to the client device for display to the user.

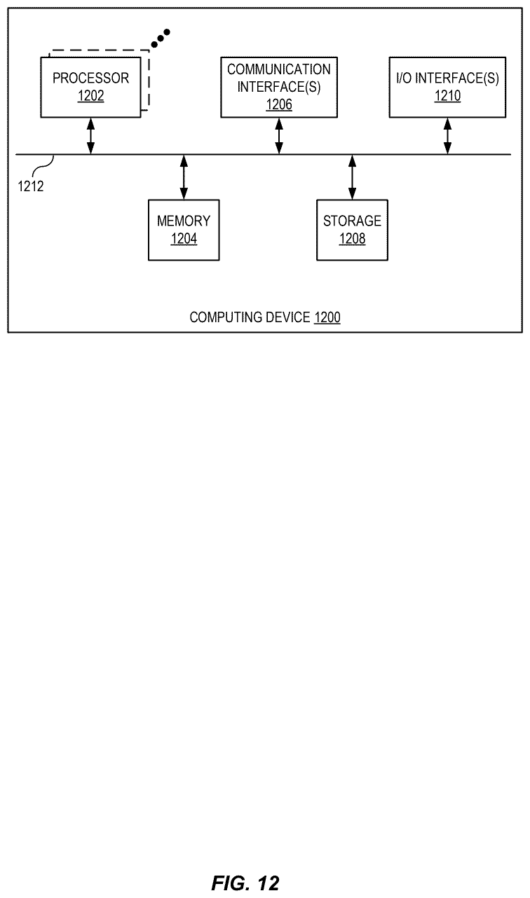

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 12. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 12.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 12.

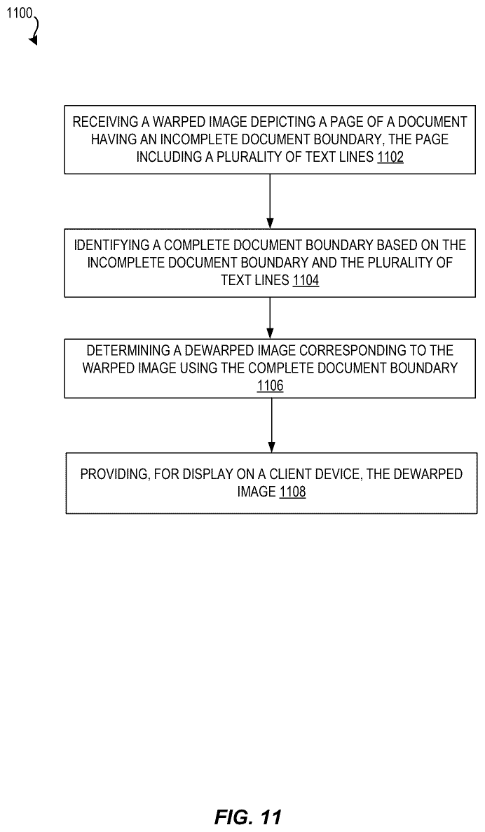

FIGS. 1-10, the corresponding text, and the examples, provide a number of different systems and devices that allows a user to obtain a document boundary. In addition to the foregoing, embodiments can also be described in terms of flowcharts comprising acts and steps in a method for accomplishing a particular result. For example, FIG. 11 illustrates a flowchart of an exemplary method in accordance with one or more embodiments. The method described in relation to FIG. 11 may be performed with fewer or more steps/acts or the steps/acts may be performed in differing orders. Additionally, the steps/acts described herein may be repeated or performed in parallel with one another or in parallel with different instances of the same or similar steps/acts.

FIG. 11 illustrates a flowchart 1100 of a series of acts in a method of determining a document boundary to dewarp an image of a document, in accordance with one or more embodiments. In one or more embodiments, the method 1100 is performed in a digital medium environment that includes the dewarping system 1000. The method 1100 is intended to be illustrative of one or more methods in accordance with the present disclosure and is not intended to limit potential embodiments. Alternative embodiments can include additional, fewer, or different steps than those articulated in FIG. 11.

As illustrated in FIG. 11, the method 1100 includes an act 1102 of receiving a warped image depicting a page of a document having an incomplete document boundary, the page including a plurality of text lines. The page of the document including the distorted document boundary can be a cropped image of a document. A cropped image of a document is an image of a document that is content-focused (e.g., the image maximizes the view of the content by removing non-content information such as the document boundary). For example, one or more upstream processes may extract or otherwise emphasize the content of the image. During such extraction, straight lines are used to discard portions of the image that are not content. Accordingly, the straight lines can crop the image such that the image is not a complete representation of the image of the document (e.g., one or more portions of the image of the document are removed such as the boundary of the document). Additionally or alternatively, the image of the document can be captured with an incomplete document boundary.

As illustrated in FIG. 11, the method 1100 includes an act 1104 of identifying a complete document boundary based on the incomplete document boundary and the plurality of text lines. As described herein, boundary curves are determined for each side of a document and subsequently connected to determine the complete document boundary. The complete document boundary is a collection of document boundaries associated with each side of the document. For example, the complete document boundary is a continuous representation of the left document boundary, the right document boundary, the upper document boundary, and the lower document boundary. Each document boundary is determined using a curve that fits a set of representative points, where each point of the set of representative points is determined using intermediate points included in a probable document boundary region. Each probable document boundary region is generated based on an intersection of an equidistant line of a set of equidistant lines and a set of parallel curves. The set of parallel curves are based on text curves corresponding to text content of the document, and the set of equidistant lines is part of a grid generated based on a width (or height) of a document and the text curves.

As illustrated in FIG. 11, the method 1100 includes an act 1106 of determining a dewarped image corresponding to the warped image using the complete document boundary. Any one or more dewarping processes can be used to dewarp the image using the document boundary, as discussed herein.

As illustrated in FIG. 11, the method 1100 includes an act 1108 of presenting, for display on a client device, the dewarped image. The dewarped image of the document includes the same content as the page of the document including the distorted document boundary but is dewarped. For example, text that appears visually curved in the page of the document including the distorted document boundary (e.g., warped content) appears visually flat in the dewarped image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates, in block diagram form, an exemplary computing device 1200 that may be configured to perform one or more of the processes described above. One will appreciate that one or more computing devices such as the computing device 1200 may implement the dewarping system. As shown by FIG. 12, the computing device can comprise a processor 1202, memory 1204, one or more communication interfaces 1206, a storage device 1208, and one or more I/O devices/interfaces 1210. In certain embodiments, the computing device 1200 can include fewer or more components than those shown in FIG. 12. Components of computing device 1200 shown in FIG. 12 will now be described in additional detail.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1208 and decode and execute them. In various embodiments, the processor(s) 1202 may include one or more central processing units (CPUs), graphics processing units (GPUs), field programmable gate arrays (FPGAs), systems on chip (SoC), or other processor(s) or combinations of processors.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1204 may be internal or distributed memory.

The computing device 1200 can further include one or more communication interfaces 1206. A communication interface 1206 can include hardware, software, or both. The communication interface 1206 can provide one or more interfaces for communication (such as, for example, packet-based communication) between the computing device and one or more other computing devices 1200 or one or more networks. As an example and not by way of limitation, communication interface 1206 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can comprise hardware, software, or both that couples components of computing device 1200 to each other.

The computing device 1200 includes a storage device 1208 includes storage for storing data or instructions. As an example, and not by way of limitation, storage device 1208 can comprise a non-transitory storage medium described above. The storage device 1208 may include a hard disk drive (HDD), flash memory, a Universal Serial Bus (USB) drive or a combination these or other storage devices. The computing device 1200 also includes one or more input or output (“I/O”) devices/interfaces 1210, which are provided to allow a user to provide input to (such as user strokes), receive output from, and otherwise transfer data to and from the computing device 1200. These I/O devices/interfaces 1210 may include a mouse, keypad or a keyboard, a touch screen, camera, optical scanner, network interface, modem, other known I/O devices or a combination of such I/O devices/interfaces 1210. The touch screen may be activated with a stylus or a finger.

The I/O devices/interfaces 1210 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1210 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a warped image depicting a page of a document having an incomplete document boundary, the page including a plurality of text lines;
identifying a complete document boundary based on the incomplete document boundary and the plurality of text lines;
determining a dewarped image corresponding to the warped image using the complete document boundary; and
providing, for display on a client device, the dewarped image.

2. The method of claim 1, wherein identifying a complete document boundary based on the incomplete document boundary and the plurality of text lines, further comprises:
generating a grid based on the plurality of text lines and a width of the page, wherein the grid includes a plurality of parallel curves associated with the plurality of text lines and a plurality of equidistant vertical lines across the width of the page;
identifying, using the grid, a set of representative points within a probable document boundary region of the warped image; and
determining the complete document boundary using the set of representative points.

3. The method of claim 2, wherein determining the complete document boundary using the set of representative points, further comprises:
fitting at least one parametric curve to the set of representative points.

4. The method of claim 2, wherein identifying, using the grid, a set of representative points within a probable document boundary region of the warped image further comprises:
determining a probable document boundary region associated with the plurality of parallel curves and an equidistant vertical line of the plurality of equidistant vertical lines;
determining a plurality of intersections between the plurality of parallel curves and the plurality of equidistant vertical lines within the probable document boundary region; and
determining a representative point based on the plurality of intersections.

5. The method of claim 2, wherein generating the grid based on the plurality of text lines further comprises:
dividing the document into a first half and a second half, wherein a first grid is generated according to a first set of the plurality of text lines associated with the first half and a second grid is generated according to a second set of the plurality of text lines associated with the second half.

6. The method of claim 5, wherein identifying, using the grid, a set of representative points within a probable document boundary region of the warped image, further comprises:
determining, using the first grid, an upper probable boundary region;
identifying a first set of representative points within the upper probable boundary region corresponding to an upper side boundary;
determining, using the second grid, a lower probable boundary region; and
identifying a second set of representative points within the lower probable boundary region corresponding to a lower side boundary.

7. The method of claim 6, further comprising:
determining the upper side boundary using the first set of representative points; and
determining the lower side boundary using the second set of representative points.

8. A system comprising:
a memory component; and
a processing device coupled to the memory component, the processing device to perform operations comprising:
receiving a warped image depicting a page of a document having an incomplete document boundary, the page including a plurality of text lines;
identifying a complete document boundary based on the incomplete document boundary and the plurality of text lines;
determining a dewarped image corresponding to the warped image using the complete document boundary; and
providing, for display on a client device, the dewarped image.

9. The system of claim 8, wherein the operation of identifying a complete document boundary based on the incomplete document boundary and the plurality of text lines, further comprises:
generating a grid based on the plurality of text lines and a width of the page, wherein the grid includes a plurality of parallel curves associated with the plurality of text lines and a plurality of equidistant vertical lines across the width of the page;
identifying, using the grid, a set of representative points within a probable document boundary region of the warped image; and
determining the complete document boundary using the set of representative points.

10. The system of claim 9, wherein the operation of determining the complete document boundary using the set of representative points, further comprises:
fitting at least one parametric curve to the set of representative points.

11. The system of claim 9, wherein the operation of identifying, using the grid, a set of representative points within a probable document boundary region of the warped image further comprises:
determining a probable document boundary region associated with the plurality of parallel curves and an equidistant vertical line of the plurality of equidistant vertical lines;
determining a plurality of intersections between the plurality of parallel curves and the plurality of equidistant vertical lines within the probable document boundary region; and
determining a representative point based on the plurality of intersections.

12. The system of claim 9, wherein the operation of generating the grid based on the plurality of text lines further comprises:
dividing the document into a first half and a second half, wherein a first grid is generated according to a first set of the plurality of text lines associated with the first half and a second grid is generated according to a second set of the plurality of text lines associated with the second half.

13. The system of claim 12, wherein the operation of identifying, using the grid, a set of representative points within a probable document boundary region of the warped image, further comprises:
determining, using the first grid, an upper probable boundary region;
identifying a first set of representative points within the upper probable boundary region corresponding to an upper side boundary;
determining, using the second grid, a lower probable boundary region; and
identifying a second set of representative points within the lower probable boundary region corresponding to a lower side boundary.

14. The system of claim 13, wherein the operations further comprise:
determining the upper side boundary using the first set of representative points; and
determining the lower side boundary using the second set of representative points.

15. A non-transitory computer-readable medium storing executable instructions, which when executed by a processing device, cause the processing device to perform operations comprising:
receiving, via a graphical user interface (GUI), a user selection to dewarp a warped image of a document having an incomplete boundary;
determining a complete document boundary of the warped image of the document based on text included in the warped image of the document;
dewarping the warped image of the document based on the complete document boundary; and
providing, for display on the GUI, the dewarped image.

16. The non-transitory computer-readable medium of claim 15, storing instructions that further cause the processing device to perform operations comprising:
determining a plurality of parallel curves associated with a plurality of text lines included in the document; and
determining a plurality of equidistant vertical lines across a width of a page.

17. The non-transitory computer-readable medium of claim 16, storing instructions that further cause the processing device to perform operations comprising:
determining a probable document boundary region associated with the plurality of parallel curves and an equidistant vertical line of the plurality of equidistant vertical lines; and
determining a representative point associated with the probable document boundary region.

18. The non-transitory computer-readable medium of claim 16, storing instructions that further cause the processing device to perform operations comprising:
determining the complete document boundary by fitting a curve using a plurality of representative points, the plurality of representative points are associated with the plurality of equidistant vertical lines.

19. The non-transitory computer-readable medium of claim 17, determining the representative point associated with the probable document boundary region causes the processing device to perform operations comprising:
determining a set of intermediate points, wherein the set of intermediate points is based on intersections of the plurality of parallel curves and the plurality of equidistant vertical lines.

20. The non-transitory computer-readable medium of claim 19, determining the representative point associated with the probable document boundary region causes the processing device to perform operations comprising:
averaging the set of intermediate points with respect to a number of the plurality of parallel curves.
